(19) United States
(12) Patent Application Publication
(10) Pub. No.: US 2010/0182679 A1
(43) Pub. Date: Jul. 22, 2010

(54) Pressure-Sensitive Adhesive Composition,Optical Filter and Plasma Display Panel Display Device Using the Same

(76) Inventors: In Cheon Han, Seoul (KR); Seung Joon Park, Daejeon (KR); Suk Ky Jang, Daejeon (KR); Ji Yeon Seong, Gyeonggi-do (KR)

Correspondence Address: MCKENNA LONG & ALDRIDGE LLP, 1900 K STREET, NW, WASHINGTON, DC, 20006, US

(21) Appl. No.: 12/449,224

(22) PCT Filed: Jan. 17, 2008
(86) PCT No.: PCT/KR2008/000288

§ 371 Date: Mar. 15, 2010

(30) Foreign Application Priority Data
Feb. 2, 2007 (KR) 10-2007-0011034

(51) Int. Cl. B32B 33/00; C08F 220/10; C08L 31/02; G02B 5/20

(52) U.S. Cl. 359/359; 428/40.1; 526/318.4; 526/318.45; 525/375; 525/374; 525/385; 525/342; 524/270; 524/556; 359/580

(57) ABSTRACT

The present invention relates to a pressure-sensitive adhesive composition for optical filter used in Plasma Display Panel (PDP), a pressure-sensitive adhesive film, an optical filter and a PDP panel display device, using the same. More specifically, the present invention relates to a pressure-sensitive adhesive composition having a dynamic storage elastic modulus of 5×10³˜5×10⁴ Pa and a dynamic loss elastic modulus of 5×10²˜5×10³ Pa, at a temperature of 30° C. and a frequency of 0.01 Hz, and a dynamic storage elastic modulus of 8×10³˜1×10⁵ Pa and a dynamic loss elastic modulus of 1×10³˜5×10⁴ Pa, at a temperature of 30° C. and a frequency of 500 Hz. The pressure-sensitive adhesive according to the present invention and the optical filter applied by the adhesive comply with endurance reliability under high temperature/high humidity conditions, do not cause fine bubbles on bonding the optical filter directly to PDP and have excellent re-workability in adhering processes.

### TECHNICAL FIELD

The present invention relates to a pressure-sensitive adhesive composition for optical filter used in Plasma Display Panel (PDP), a pressure-sensitive adhesive film, an optical filter and a PDP display device, using the same. More specifically, the present invention relates to a pressure-sensitive adhesive for optical filter having excellent endurance reliability under high temperature/high humidity conditions, causing no fine bubble, on bonding the optical filter directly to a PDP panel and having excellent re-workability, and an optical filter using the same.

### BACKGROUND ART

Recently, as expectations are increased for high fidelity/big screen televisions, including digital televisions, researches are actively proceeding for getting larger in fields such as cathode-ray tube (CRT), liquid crystal display (LCD) and plasma display (PDP).

Conventionally, the CRT used widely in display of televisions has excellent resolution and image quality, but is not suitable for a big screen having a size of 40 inches or more, due to a disadvantage such that its length and weight become larger depending on size of picture.

In addition, in case of LCD, there is an advantage that it has low power consumption and excellent driving voltage, but there are a technical drawback in preparing big screen and a disadvantage which has limit of view angle.

Meanwhile, in case of PDP, big screen may be realized and mass products as much as 60 inches have been developed. PDP elements are disposed in parallel such that partitioned barriers are formed on a bottom plate, red, green and blue fluorescent substance layers are formed on grooves of the barriers, and electrodes of said bottom plate are faced with electrodes of an upper plate. Said upper and bottom plates are sealed and discharge gases are enclosed within their inside. Plasma occurred on discharging said enclosed gases is divided by fine barriers to compose unit cells, and image is provided, using them.

However, since electrodes for providing signal and electric power are positioned on the whole surface of front glass, PDP generates a large quantity of electromagnetic waves over other displays on driving it. In addition, near infrared is generated, so that light in the corresponding near infrared areas may be caused by malfunction of remote controls, or infrared communication ports. Meanwhile, emission of the three primary colors is embodied with light-emitting each fluorescent substance of red (R), blue (B), and green (G) by vacuum ultraviolet after enclosing discharge gases such as Ne, Ar, or Xe, but when the neon atoms are returned to the ground state after being excited, emission of neon orange light around 590 nm is present. Thus, there is a problem that cannot obtain clear red.

To solve such problems of plasma display panel, an optical filter for plasma display panel (referred to optical filter for PDP, below) is set up on a front part of a panel assembly. If the optical filter for PDP is set up, visible rays of R, G, and B are transmitted to the filter as such, and orange neon wavelength with a wavelength of 590 nm and near infrared with a wavelength range of 800 to 1,000 nm, lowering resolution of screen, are interrupted.

In addition, said optical filter serves simultaneously to improve color clearness, reflective resistance and contrast through color compensating layer.

Recently, optical filters are generally used in such a shape that a transparent film equipped with a transparent conductive layer and a near infrared shielding layer is adhered to a glass plate with a pressure-sensitive adhesive. However, there are problems that such optical filter with this shape has high light reflection at an air layer between PDP and the optical filter, damages image quality of PDP due to deterioration of contrast, and restricts thinning PDP.

To solve such problems, an optical filter (film filter, below) has been developed to be used, using only a film but not glass. Since such film filter is adhered directly to glass of a panel using a pressure-sensitive adhesive, endurance reliability is required under high temperature/high humidity conditions. In addition, since the process of adhering the film filter is practiced in very prompt speed, a large quantity of fine bubbles may be caused on bonding. Thus, there is a need for a pressure-sensitive adhesive that fine bubbles are not generated on bonding. Further, since the film filter is adhered directly to PDP, it should be removed from the panel, if defects are caused on bonding. In this case, re-workability is required such that traces of pressure-sensitive adhesive are not remained.

Therefore, it is earnestly required to develop a pressure-sensitive adhesive which complies with endurance reliability under high temperature/high humidity conditions but does not generate fine bubbles on bonding a film filter to PDP and has excellent re-workability in a process of adhering.

Generally, rubber, acryl, or silicone based adhesives, and the like are widely used as a pressure-sensitive adhesive. Among these, acrylic pressure-sensitive adhesives have various application properties so that they are most widely used in preparing high functional pressure-sensitive adhesive compositions. Physical properties of such pressure-sensitive adhesives are highly affected by their viscoelastic properties. To regulate said viscoelastic properties, appropriate molecular structure properties such as constituents, molecular weights and molecular weight distributions, and cross-linking densities of pressure-sensitive adhesives are necessary.

Configurations that physical properties of pressure-sensitive adhesives for PDP film filter are related to viscoelastic properties have been proposed in various disclosures, whereas only a configuration for improving impact resistance is described in these disclosures.

Specifically, JP Unexamined Patent Publication Nos. 2003-29645 and 2003-29644 disclose pressure-sensitive adhesives with improved impact resistance by defining ranges of dynamic storage elastic modulus in frequencies of 1 Hz and 10⁻⁷ Hz at 20° C., but endurance reliability of pressure-sensitive adhesives under high temperature/high humidity conditions and consideration of fine bubbles on bonding are not described therein.

JP Unexamined Patent Publication No. 2004-263084 discloses pressure-sensitive adhesives for PDP optical filter defining ranges of dynamic storage elastic modulus and dynamic loss elastic modulus at 25° C. as 1,000 to 10,000 Hz. However, the above disclosure also describes viscoelastic property only for purpose to improve impact resistance of the optical filter, but endurance reliability of a film filter and consideration of viscoelastic ranges about fine bubbles on bonding are not disclosed therein.

JP Unexamined Patent Publication No. 2005-23133 discloses pressure-sensitive adhesive compositions with improved impact resistance and excellent re-workability by defining dynamic storage elastic modulus at 25° C. as 1,000 to 10,000 Hz. However, in the above disclosure, contents are also not disclosed about viscoelastic property of fine bubbles generated on bonding the film filter.

In addition, JP Unexamined Patent Publication No. 2006-171261 discloses pressure-sensitive adhesive compositions with improved impact resistance and excellent re-workability, but fine bubbles generated on bonding the film filter and viscoelastic property about endurance reliability are not mentioned therein.

### DISCLOSURE

### Technical Solution

The present invention is intended to solve the problems described above. One object of the present invention is to provide a pressure-sensitive adhesive composition for optical filter having excellent endurance reliability under high temperature/high humidity conditions, generating no fine bubbles on bonding the optical filter directly to PDP and having excellent re-workability.

The other object of the present invention is to provide a pressure-sensitive adhesive film, an optical filter and a plasma display panel (PDP) display device, using the pressure-sensitive adhesive composition.

### DESCRIPTION OF DRAWINGS

FIG. 1 is one embodiment of pressure-sensitive adhesive film according to the present invention.

FIG. 2 is one embodiment of optical filter according to the present invention.

FIG. 3 is one embodiment of display panel display device according to the present invention.

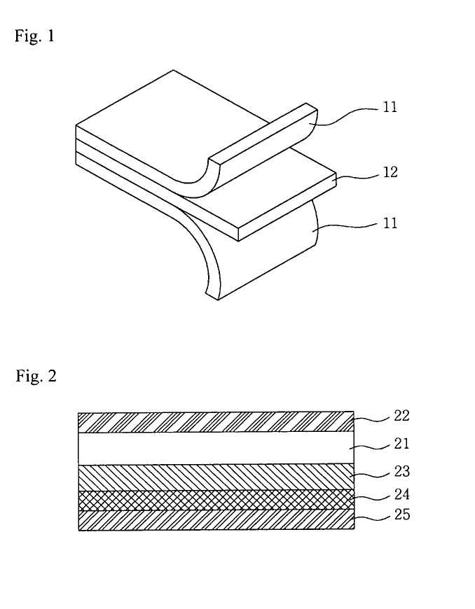

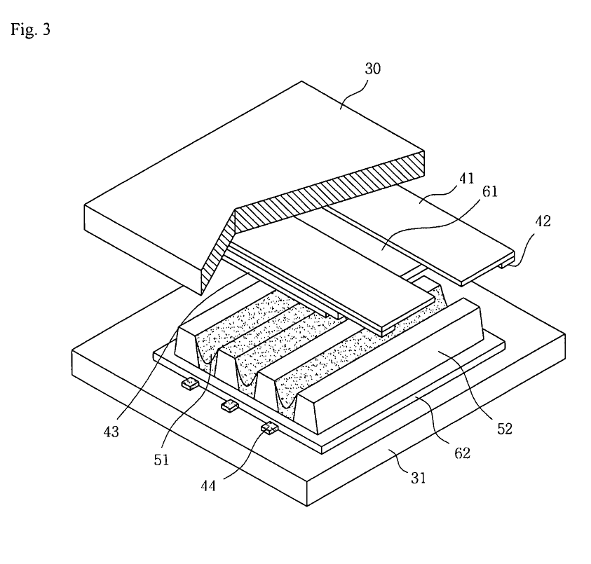

### REFERENCES IN DRAWINGS

11: Release Film
12: Pressure-sensitive adhesive layer
21: Transparent substrate
22: Antireflective light transmission film (AR film)
23: Near infrared barrier layer (NIR)
24: Neon cut film
25: Electromagnetic interference film (EMI film)
30: Upper plate
31: Bottom plate
41: ITO electrode
42: BUS electrode
43: Protective layer (MgO)
44: Address electrode
51: Fluorescent substance
52: Barrier rib
61: Transparent dielectric layer
62: Bottom plate dielectric layer

### BEST MODE

The present invention is intended to accomplish the objects above and relates to a pressure-sensitive adhesive composition having a dynamic storage elastic modulus of 5×10³˜5×10⁴ Pa and a dynamic loss elastic modulus of 5×10²˜5×10³ Pa, at a temperature of 30° C. and a frequency of 0.01 Hz, and a dynamic storage elastic modulus of 8×10³˜1×10⁵ Pa and a dynamic loss elastic modulus of 1×10³˜5×10⁴ Pa, at a temperature of 30° C. and a frequency of 500 Hz.

Adhesion property of the pressure-sensitive adhesive is in close relationship with its viscoelastic property. To prepare pressure-sensitive adhesives having excellent adhesion property, it is necessary regulation of viscoelastic property. Therefore, the composition according to the present invention is characterized by having optimal viscoelastic property for controlling generation of fine bubbles and providing excellent endurance reliability.

More specifically, the present pressure-sensitive adhesive composition has a dynamic storage elastic modulus of 5×10³˜5×10⁴ Pa and a dynamic loss elastic modulus of 5×10²˜5×10³ Pa, at a temperature of 30° C. and a frequency of 0.01 Hz, and a dynamic storage elastic modulus of 8×10³˜1×10⁵ Pa and a dynamic loss elastic modulus of 1×10³˜5×10⁴ Pa, at a temperature of 30° C. and a frequency of 500 Hz.

More preferred viscoelastic property herein is a dynamic storage elastic modulus of 6×10³˜2×10⁴ Pa and a dynamic loss elastic modulus of 6×10²˜4×10³ Pa, at a temperature of 30° C. and a frequency of 0.01 Hz, and a dynamic storage elastic modulus of 9×10³˜8×10⁴ Pa and a dynamic loss elastic modulus of 2×10³˜4×10⁴ Pa, at a temperature of 30° C. and a frequency of 500 Hz.

Most preferred viscoelastic property herein is a dynamic storage elastic modulus of 7×10³˜1×10⁴ Pa and a dynamic loss elastic modulus of 7×10²˜3×10³ Pa, at a temperature of 30° C. and a frequency of 0.01 Hz, and a dynamic storage elastic modulus of 1×10⁴˜5×10⁴ Pa and a dynamic loss elastic modulus of 3×10³˜2×10⁴ Pa, at a temperature of 30° C. and a frequency of 500 Hz.

If the dynamic storage elastic modulus at a temperature of 30° C. and a frequency of 0.01 Hz is less than 5×10³ Pa, endurance reliability under high temperature/high humidity conditions is insufficient. If it is in excess of 5×10⁴ Pa, it is hard to obtain sufficient bonding strength due to impaired wettability in interfaces on bonding the composition directly to PDP. In addition, if the dynamic storage elastic modulus at a frequency of 500 Hz is less than 8×10³ Pa, endurance reliability is insufficient. If it is in excess of 1×10⁵ Pa, a large quantity of fine bubbles are generated, when an optical filter is adhered to PDP.

Meanwhile, if the dynamic loss elastic modulus at a temperature of 30° C. and a frequency of 0.01 Hz is less than 5×10² Pa, endurance reliability is insufficient. If it is in excess of 5×10³ Pa, re-workability is poor. In addition, if the dynamic loss elastic modulus at a frequency of 500 Hz is less than 1×10³ Pa, sufficient bonding strength is not obtained so that a phenomenon of which an optical filter is deviated from the panel is developed. If it is in excess of 5×10⁴ Pa, there is a problem that re-workability is poor.

Hereinafter, the present invention is explained in detail as follow.

The present pressure-sensitive adhesive composition may be used without limitation, as long as it is characterized by having the dynamic storage elastic modulus and the dynamic loss elastic modulus in the ranges above. In the usable pressure-sensitive adhesive composition herein, all adhesion or bonding materials to be optically used such as acryl, silicone, rubber, urethane, polyester, or epoxy based materials may be applied without limitation, but preferably acrylic pressure-sensitive adhesive among them.

Preferably, said acrylic pressure-sensitive adhesive comprises an acrylic copolymer containing 90 to 99.9 parts by weight of (meth)acrylic acid ester monomer having an alkyl group of 1 to 12 carbon atoms, and 0.1 to 10 parts by weight of vinyl monomer including an acid group or 0.01 to 5 parts by weight of vinyl monomer including a hydroxyl group.

When the alkyl group in said (meth) acrylic acid ester monomer having an alkyl group of 1 to 12 carbon atoms is a long-chain shape, cohesion strength of pressure-sensitive adhesives is lowered. Therefore, to maintain cohesion strength at high temperature, it is more preferred to select carbon atoms in the alkyl group from ranges of 2 to 8. Specifically, one or more selected from the group consisting of methyl(meth)acrylate, ethyl(meth)acrylate, n-propyl(meth)acrylate, isopropyl(meth)acrylate, n-butyl(meth)acrylate, t-butyl(meth)acrylate, sec-butyl(meth)acrylate, pentyl(meth)acrylate, 2-ethylbutyl(meth)acrylate, 2-ethylhexyl(meth)acrylate, n-octyl(meth)acrylate, isooctyl(meth)acrylate, and isononyl(meth)acrylate may be used.

If the amount of said (meth) acrylic acid ester monomer is less than 90 parts by weight, there is a problem that initial adhesion property is lowered. If it is in excess of 99.9 parts by weight, cohesion failure may be caused on raising temperature.

The vinyl monomer containing an acid group used herein is a component for reacting with a cross-linking agent and giving the pressure-sensitive adhesive cohesion strength by chemical bonds such that cohesion failure of the adhesive is not occurred on raising temperature.

Said vinyl monomer containing an acid group may include one or more selected from the group consisting of a copolymerizable monomer containing a carboxyl group or anhydride thereof, a copolymerizable monomer containing a sulfonic acid group, and a copolymerizable monomer containing a phosphoric acid group.

Said copolymerizable monomer containing a carboxyl group is (meth) acrylic acid, carboxyethyl acrylate, carboxypentyl acrylate, itaconic acid, maleic acid, fumaric acid, or crotonic acid;

the anhydride of copolymerizable monomer containing a carboxyl group is maleic anhydride or itaconic anhydride;

the copolymerizable monomer containing a sulfonic acid group is styrene sulfonic acid, allyl sulfonic acid, 2-(meth)acrylamide-2-methyl propane sulfonic acid, (meth)acrylamide propane sulfonic acid, sulfopropyl (meth)acrylate, (meth)acryloyloxy naphthale sulfonic acid; and

the copolymerizable monomer containing a phosphoric acid group may be selected from 2-hydroxyethyl acryloyl phosphate, and the like, but not limited thereto.

Said vinyl monomer including an acid group is preferably included in an amount of 0.1 to 10 parts by weight relative to total content of acrylic copolymers. If the amount is less than 0.1 parts by weight, cohesion failure is easily occurred on raising temperature. If the amount is in excess of 10 parts by weight, flowing characteristic at elevated temperature is reduced.

In addition, vinyl monomer including a hydroxyl group is a component that gives the pressure-sensitive adhesive cohesion strength by chemical bonds alone or by reacting with a cross-linking agent, such that cohesion failure of the adhesive is not occurred on raising temperature.

In addition, the vinyl monomer containing a hydroxyl group includes, but not limited to, for example, 2-hydroxyethyl (meth)acrylate, 2-hydroxypropyl (meth)acrylate, 2-hydroxyethyleneglycol (meth)acrylate, 2-hydroxypropyleneglycol (meth)acrylate and a mixture thereof.

Said vinyl monomer including a hydroxyl group is preferably included in an amount of 0.01 to 5 parts by weight relative to total content of acrylic copolymers. If the amount is less than 0.01 parts by weight, cohesion failure is easily developed on raising temperature. If the amount is in excess of 5 parts by weight, flowing characteristic at elevated temperature is reduced.

To regulate the glass transition temperature of the pressure-sensitive adhesive or provide other functionalities, it is preferred that the acrylic copolymer further comprises a functional monomer of Formula 1 in 0 to 20 parts by weight relative to weight of total monomers, if necessary.

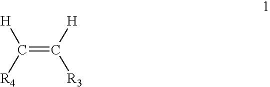

wherein,

R₄ represents hydrogen or alkyl,

R₃ represents cyano, phenyl unsubstituted or substituted with alkyl, acetyloxy, or COR₅, where R₅ represents amino or glycidyloxy unsubstituted or substituted with alkyl.

In the formula above, alkyl in definitions of R₃ to R₅, preferably, represents lower alkyl of 1 to 6 carbon atoms, and more preferably, methyl or ethyl.

Examples of said compound of Formula 1 may include, but not limited to, styrene monomers such as styrene or alpha methyl styrene; carboxylic acid vinyl esters such as vinyl acetate; or nitrogen containing monomers such as acrylonitrile, (meth)acryl amide, N-methyl(meth)acryl amide, N-butoxy methyl(meth)acryl amide, or glycidyl(meth)acrylate. Said monomers may be used alone in a mixture thereof.

If the amount of said functional monomer of Formula 1 is too high, the flexibility and the release strength of pressure-sensitive adhesive are lowered. Therefore, it is preferred to use less than 20 parts by weight of total monomer components.

Preferably, the acrylic pressure-sensitive adhesive according to the present invention further comprises 0.01 to 10 parts by weight of a cross-linking agent relative to 100 parts by weight of an acrylic copolymer. Said cross-linking agent serves to improve adhesion reliability by maintaining cohesion strength of pressure-sensitive adhesive on raising temperature through formation of cross-linking structure.

Kinds of said cross-linking agents are not specifically limited, but may use one or more selected from the group consisting of an isocyanate compound, an epoxy compound, an aziridine compound, and a metal chelate compound.

Said isocyanate compound is preferably one or more multifunctional isocyanate compounds selected from the group consisting of tolylene diisocyanate, xylene diisocyanate, diphenylmethane diisocyanate, hexamethylene diisocyanate, isoform diisocyanate, tetramethylxylene diisocyanate, naphthalene diisocyanate, and a reactant thereof with polyol (trimethylolpropane, etc.).

Said epoxy compound is preferably bisphenol A-epichlorohydrine typed epoxy resin, ethyleneglycol diglycidylether, polyethyleneglycol diglycidylether, triglycidylether, glycerine diglycidylether, glycerine triglycidylether, 1,6-hexanediol diglycidylether, trimethylolpropane triglycidylether, diglycidylether aniline, N,N,N′N′-tetraglycidyl-m-xylenediammine, N,N,N′N′-tetraglycidylethylenediamine, or N,N,N′N′-tetraglycidyl-1,3-dimethylbenzene.

Said aziridine compound may be one or more selected from the group consisting of N,N′-toluene-2,4-bis(1-aziridinecarboxide), N,N′-diphenylmethane-4,4′-bis(1-aziridinecarboxide), triethylenemelamine, bisiso-prothaloyl-1-(2-methylaziridine), and tri-1-aziridinylphosphineoxide, and

said metal chelating compound may be used, but not limited to, such as one or more selected from a compound that a multivalent metal such as aluminum, iron, zinc, tin, antimony, magnesium and vanadium is coordinated with acethylacetone or ethyl acetoacetate.

Particularly, said multi-functional isocyanate cross-linking agent is preferred in that no cross-linking reaction of isocyanate functional groups may be occurred to practice uniform coating works. Also, after finishing such coating works followed by drying and aging procedures, the pressure-sensitive adhesive layer with improved cohesion may be obtained, with forming the cross-linking structure. Then, adhesion properties and cuttability of adhesion products are improved by the strong cohesion of pressure sensitive adhesive.

Said cross-linking agent used herein is preferably included in an amount of 0.01 to 10 parts by weight relative to 100 parts by weight of an acrylic copolymer. If the amount is less than 0.01 parts by weight, it is so low that the reaction is not almost occurred. If it is in excess of 10 parts by weight, an excess of cross-linking reaction is proceeded to represent inter-layer release and thus durability is rather lowered.

Preferably, the cross-linking density of an acrylic copolymer according to the present invention is 1 to 95%. When the cross-linking density is too low and thus the elastic modulus of pressure-sensitive adhesive is too low, bubbles are caused between layers at high temperature state to form scatterers. When the pressure-sensitive adhesive with too high elastic modulus is used for a long time, inter-layer release phenomenon is caused due to an excess of cross-linking reaction. In addition, the viscoelastic property of pressure-sensitive adhesive mainly depends on molecular weight, molecular weight distribution, or molecular structure of polymer chains, and especially is determined by molecular weight. Therefore, the weight average molecular weight of acrylic copolymer used herein is preferably 600,000 to 2,000,000, and may be regulated through usual radical copolymerizing procedure. If the molecular weight of copolymer is less than 600,000, cohesion strength of pressure-sensitive adhesive is too low. If the molecular weight is more than 2,000,000, adhesion property is insufficient.

In the present invention, the acrylic copolymer may be prepared by polymerization methods such as solution polymerization, photo-polymerization, bulk polymerization, suspension polymerization, or emulsion polymerization, and more preferably solution polymerization. At this time, the polymerization temperature is 50 to 140° C. It is preferred to add an initiator in a state that monomers are homogeneously mixed. The present acrylic pressure-sensitive adhesive resin composition for optical filter may be also prepared by photo-polymerization method with selection of the appropriate photo-initiators as generally well known.

In addition, the acrylic pressure-sensitive adhesive according to the present invention may further comprise 0.01 to 10 parts by weight of a silane coupling agent to improve adhesion durability. The silane coupling agent serves to increase endurance reliability by increasing adhesion strength with time and heat to prevent bubbles or release under high temperature/high humidity conditions. Said silane coupling agent may use one or more selected from the group consisting of β-(3,4-epoxycyclohexyl), γ-glycycloxypropyl trimethoxysilane, γ-glycycloxypropyl methyldiethoxysilane, γ-glycycloxypropyl tri-ethoxysilane, 3-mercaptopropyl trimethoxysilane, vinyl trimethoxysilane, vinyl tri-ethoxysilane, γ-methacryloxypropyl trimethoxysilane, γ-methacryloxypropyl tri-ethoxysilane, γ-aminopropyl triethoxysilane, 3-isocyanatepropyl triethoxysilane, and γ-acetoacetatepropyl trimethoxysilane, but not limited thereto.

Said silane coupling agent is preferably included in an amount of 0.01 to 10 parts by weight relative to 100 parts by weight of an acrylic copolymer. If the amount is less than 0.01 parts by weight, increase of adhesion strength by time and heat is slight. If it is in excess of 10 parts by weight, bubbles or release is rather caused due to an excess use to have a problem that endurance reliability is lowered.

In addition to these, it is preferred that the pressure-sensitive adhesive according to the present invention further comprises 1 to 100 parts by weight of a tackifier resin relative to 100 parts by weight of an acrylic copolymer to regulate adhesion efficiency. When an excess of said ingredient is used, cohesion strength of pressure-sensitive adhesive may be reduced. Therefore, it is preferred to comprise it in an appropriate amount. The tackifier resin may use a (hydrogenated) hydrocarbon resin, a (hydrogenated) rosin resin, a (hydrogenated) rosin ester resin, a (hydrogenated) terpene resin, a (hydrogenated) terpene phenol resin, a polymerized rosin resin, or a polymerized rosin ester resin, and the like.

In addition, the pressure-sensitive adhesive composition according to the present invention may also further use additives such as near infrared absorbents, epoxy resins, hardeners, plasticizers, ultraviolet stabilizers, antioxidants, colorants, reinforcing agents, or fillers, if desired.

The present invention also relates to a pressure-sensitive adhesive film comprising

a release film; and

a pressure-sensitive adhesive layer, formed on the release film, containing said pressure-sensitive adhesive composition according to the present invention.

As substrate films of said release film, plastic films may be used such as polyethyleneterephthalate film, polytetrafluoroethylene film, polyethylene film, polypropylene film, polybutene film, polybutadiene film, vinylchloride copolymer film, or polyimide film. In addition, it is preferred that surfaces of said substrate film are treated by a release agent such as alkyd, silicone, fluorine, unsaturated ester, polyolefin, or wax-based agent. Especially, alkyd, silicone, or fluorine-based agent, and the like is preferred due to having heat resistance.

The substrate film has usually a thickness of 10˜500 μm, preferably 20˜200 μm.

In addition, the thickness of the coated and dried pressure-sensitive adhesive layer is not specifically limited as long as it is in ranges that high transparency is not damaged, but suitably 1˜200 μm.

Said pressure-sensitive adhesive film may be used in a variety of shapes. One example thereof is explained below, with reference to a drawing. The present pressure-sensitive adhesive film may take a form that a release film 11 is adhered to both sides of a pressure-sensitive adhesive layer 12. In such case, after releasing a release film 11 adhered to one side of the pressure-sensitive adhesive layer 12, the adhesive layer may be transferred to the desired adherend, for example, a polarizing plate or an optical filter. Then, after releasing the other side release film 11 remained in the adhesive layer 12, another adherend, for example, display module, and the like may be adhered thereto.

The present invention also relates to an optical filter comprising the pressure-sensitive adhesive layer containing said pressure-sensitive adhesive composition according to the present invention.

One example of the present optical filter is explained below, with reference to a drawing.

It is preferred that the optical filter according to the present invention has a structure in which an antireflective light transmission film (AR film) 22 is laminated on the transparent substrate 21, near infrared barrier layer (NIR) 23, neon cut (color compensating, selective absorbing) film 24, and electromagnetic interference film (EMI film) 25, and the like, are laminated on its backing.

The antireflective light transmission film 22, the near infrared barrier layer (NIR) 23, the neon cut (color compensating, selective absorbing) film 24, and the electromagnetic interference film (EMI film) 25 composing said optical filter may use generally used ones used in this field, and are not specifically limited. Of course, for further functions, films with various functions beside films described above may further be included.

The optical filter according to the present invention is formed on one or both sides of the optical filter described above, and it has the pressure-sensitive adhesive layer containing said pressure-sensitive adhesive composition according to the present invention. In addition, said adhesive layer may be formed between each film layer of the optical filter described above.

The present invention also relates to a plasma display panel (PDP) display device comprising

a plasma display module; and

said optical filter according to the present invention.

Said plasma display module is also not specifically limited, and its example is explained below, with reference to a drawing.

It may include an ITO electrode (maintaining/scanning electrode) 41 for generating and maintaining discharge in a discharge cell; a BUS electrode 42 for compensating relatively high resistance in the transparent electrode; a transparent dielectric layer 61 for restricting discharge current and accumulating wall charge; a protective layer (MgO) 43 for protecting the transparent dielectric layer from ion collision; address electrodes 44 and bottom dielectric layer 62 for protecting them; barrier ribs 52 for ensuring certain discharge space per a discharge cell and segregating RGB fluorescent substance such that they are not mixed; and fluorescent substance 51 for receiving (vacuum) ultraviolet generated through discharge to converge/discharge it into visible light (each RGB).

Meanwhile, the present acrylic pressure-sensitive adhesive resin composition may be used in laminates, such as polarizing plate, optical functional addition film, or light modulating film, which include high functional display devices and are used for modulating optical characteristics, and may be used, without limitation for uses, such as industrial sheets, particularly, reflective sheets, structural adhesive sheets, photographic adhesive sheets, adhesive sheets for drawing traffic lanes, optical adhesive products, pressure-sensitive adhesives for electronic parts.

### MODE FOR INVENTION

Preferred examples of the present invention and comparative examples are described below. The examples and comparative examples below are described for more clearly representing contents of the present invention. However, the contents of the present invention are not restricted to examples below.

### Example 1

### Preparation of Acrylic Copolymer

To 1,000 cc reactor equipped with a cooling system for reflux of nitrogen gas and easy regulation of temperature was added a mixture of monomers consisting of 94 parts by weight of n-butylacrylate (BA), and 6 parts by weight of acrylic acid. Then, 100 parts by weight of ethyl acetate (EAc) was added thereto as a solvent. To remove oxygen, nitrogen gas was purged for 20 minutes, and the temperature was kept at 60° C. After homogenizing the mixture, 0.03 parts by weight of azobisisobutyronitrile (AIBN) diluted to 50%, as a reaction initiator, was added thereto. The mixture was reacted for 8 hour to prepare an acrylic copolymer having a molecular weight of 1,800,000.

### Preparation of Acrylic Pressure-Sensitive Adhesive

0.03 Parts by weight of N,N,N′,N′-tetragylcidyl-1,3-dimethylbenzene as an epoxy cross-linking agent and 0.2 parts by weight of tolylene diisocyanate adduct of trimethylolpropane as a multi-functional isocyanate cross-linking agent were each diluted to 10% by weight in ethylacetate solution, relative to 100 parts by weight of the acrylic copolymer prepared above, and introduced thereto. Then, the mixture was diluted in a suitable concentration and homogeneously mixed, considering the coating property. The resulting product was coated on a release film with a thickness of 38 μm and dried to prepare a 25 μm homogenous pressure-sensitive adhesive layer.

### Measurement of Dynamic Storage Elastic Modulus and Dynamic Loss Elastic Modulus

Dynamic storage elastic modulus and dynamic loss elastic modulus of the pressure-sensitive adhesive were measured using ARES by TA Co. Using a fixture of a parallel plate having a diameter of 8 mm, the pressure-sensitive adhesive was frequency swept under a condition at a specimen thickness of 1 mm and a deformation rate of 10%, and dynamic storage elastic modulus and dynamic loss elastic modulus were measured at a temperature of 30° C. and frequencies of 0.01 Hz and 500 Hz.

### Laminating

The pressure-sensitive adhesive layer prepared above was adhered to an optical filter for PDP and processed. The resulting optical filter was cut into proper sizes and used in evaluation. The optical filter, on which the pressure-sensitive adhesive was applied, was subjected to the following evaluations, and the results were represented in Table 1 below.

### Example 2

The acrylic copolymer having a molecular weight of 1,500,000 was prepared by the same method as Example 1 above except for using 97 parts by weight of n-butylacrylate (BA), 2 parts by weight of 2-hydroxylethylmethacrylate (2-HEMA), and 1 part by weight of acrylic acid (AA) as the monomer mixture in Example 1 above and subjected to evaluation.

### Example 3

The acrylic copolymer having a molecular weight of 1,200,000 was prepared by the same method as Example 1 above except for using 88 parts by weight of n-butylacrylate (BA), 8 parts by weight of ethylacrylate (EA), and 4 parts by weight of acrylic acid (AA) as the monomer mixture in Example 1 above and subjected to evaluation.

### Comparative Example 1

The acrylic copolymer having a molecular weight of 1,700,000 was prepared by the same method as Example 1 above except for using 64 parts by weight of n-butylacrylate (BA), 30 parts by weight of methylmethacrylate (MMA), and 6 parts by weight of acrylic acid as the monomer mixture in Example 1 above and subjected to evaluation.

### Comparative Example 2

The acrylic copolymer having a molecular weight of 1,300,000 was prepared by the same method as Example 1 above except for using 80 parts by weight of n-butylacrylate (BA), 19 parts by weight of 2-ethylhexylacrylate (EHA), and 1 part by weight of acrylic acid as the monomer mixture in Example 1 above and subjected to evaluation.

### Comparative Example 3

The acrylic copolymer having a molecular weight of 550,000 was prepared by the same method as Example 1 above except for using 90 parts by weight of n-butylacrylate (BA), 10 parts by weight of methylacrylate (MA), and 1 part by weight of acrylic acid as the monomer mixture in Example 1 above and subjected to evaluation.

### Experimental Example

### Evaluation of Fine Bubbles on Bonding Optical Filter

An optical filter (885 mm×498 mm), on which the pressure-sensitive adhesive prepared in Example 1 above was coated, was adhered to a PDP panel in a clean room, using a laminator. After adhesion, fine bubbles were observed using an optical microscope. Evaluation standard about generating fine bubbles on bonding is as follows:

◯: no fine bubble was observed

Δ: slight fine bubbles were generated

x: a large quantity of fine bubbles were generated

Evaluation of Endurance Reliability

In order to know moisture-heat resistant durability of the optical filters adhered to PDP panels, they were left at a temperature of 60° C. and a relative humidity of 90% for 1,000 hours and then observed about formation of bubbles or releases. Also, in order to evaluate their heat resistant durability, they were left at 80° C. for 1,000 hours and then observed about formation of bubbles or releases. The evaluation standard of endurance reliability is as follows:

◯: no bubble or release phenomenon was observed.

Δ: a few bubbles or release phenomenon was occurred.

x: a large quantity of bubbles or release phenomenon was occurred.

Evaluation of Re-Workability

The optical filter (400 mm×300 mm) was adhered to a glass substrate using a laminator and then stored at 50° C. for 4 hours, followed by releasing the optical filter from the glass substrate. The evaluation standard of re-workability is as follows:

◯: no adhesive residue was observed

Δ: slight adhesive residue was present

x: a large quantity of adhesive residue was present

TABLE 1

| | | Example | | | Comparative example | | |
|---|---|---|---|---|---|---|---|
| | | 1 | 2 | 3 | 1 | 2 | 3 |
| Dynamic | 0.01 Hz | 1 × 10⁴ | 9 × 10³ | 7 × 10³ | 9 × 10³ | 4 × 10³ | 2 × 10³ |
| storage elastic | 500 Hz | 5 × 10⁴ | 2 × 10⁴ | 1 × 10⁴ | 8 × 10⁴ | 1 × 10⁴ | 7 × 10³ |
| modulus (Pa) | | | | | | | |
| Dynamic loss | 0.01 Hz | 3 × 10³ | 1 × 10³ | 7 × 10² | 2 × 10³ | 1 × 10³ | 6 × 10² |
| elastic modulus | 500 Hz | 2 × 10⁴ | 5 × 10³ | 3 × 10³ | 7 × 10⁴ | 6 × 10⁴ | 8 × 10² |
| (Pa) | | | | | | | |

| | | | | | | |
|---|---|---|---|---|---|---|
| Molecular weight | 1,800,000 | 1,500,000 | 1,200,000 | 1,700,000 | 1,300,000 | 550,000 |
| Fine bubbles on bonding | ◯ | ◯ | ◯ | X | ◯ | ◯ |
| Endurance reliability | ◯ | ◯ | ◯ | ◯ | X | X |
| Re-workability | ◯ | ◯ | ◯ | X | Δ | X |

As shown in the result of Table 1 above, it could be identified that Examples 1 to 3 of the present invention did not cause fine bubbles on bonding the optical filters for PDP directly to PDP and had excellent endurance reliability and re-workability, whereas Comparative Example 1 caused a large quantity of fine bubbles on bonding and had poor re-workability, and Comparative Example 2 did not cause fine bubbles on bonding, but had poor endurance reliability. In addition, Comparative Example 3 with small molecular weight of 550,000 had poor endurance reliability and re-workability.

### INDUSTRIAL APPLICABILITY

Pressure-sensitive adhesives by the present invention and optical filters for PDP using the same comply with endurance reliability under high temperature/high humidity conditions and have excellent re-workability in adhering process, without causing fine bubbles on bonding the optical filters directly to PDP.

The present invention is explained in detail, with reference to the described embodiments above. It is evident to one skilled in the art that various modifications and variations are allowed within the scope and the technical spirit of the present invention. Such modifications and variations should be pertained to the attached claims.

1. A pressure-sensitive adhesive composition having a dynamic storage elastic modulus of 5×10³˜5×10⁴ Pa and a dynamic loss elastic modulus of 5×10²˜5×10³ Pa, at a temperature of 30° C. and a frequency of 0.01 Hz, and a dynamic storage elastic modulus of 8×10³˜1×10⁵ Pa and a dynamic loss elastic modulus of 1×10³˜5×10⁴ Pa, at a temperature of 30° C. and a frequency of 500 Hz.

2. The pressure-sensitive adhesive composition of claim 1, characterized in that it is acryl, silicone, rubber, urethane, polyester or epoxy based adhesive composition.

3. The pressure-sensitive adhesive composition of claim 2, characterized in that the acrylic pressure-sensitive adhesive comprises an acrylic copolymer containing 90 to 99.9 parts by weight of (meth) acrylic acid ester monomer having an alkyl group of 1 to 12 carbon atoms, and 0.1 to 10 parts by weight of vinyl monomer including an acid group or 0.01 to 5 parts by weight of vinyl monomer including a hydroxyl group.

4. The pressure-sensitive adhesive composition of claim 3, characterized in that the (meth)acrylic acid ester monomer having an alkyl group of 1 to 12 carbon atoms is one or more selected from the group consisting of methyl(meth)acrylate, ethyl(meth)acrylate, n-propyl(meth)acrylate, isopropyl(meth)acrylate, n-butyl(meth)acrylate, t-butyl(meth)acrylate, sec-butyl(meth)acrylate, pentyl(meth)acrylate, 2-ethylbutyl(meth)acrylate, 2-ethylhexyl(meth)acrylate, n-octyl(meth)acrylate, isooctyl(meth)acrylate, and isononyl(meth)acrylate.

5. The pressure-sensitive adhesive composition of claim 3, characterized in that the vinyl monomer containing an acid group is one or more selected from the group consisting of a copolymerizable monomer containing a carboxyl group or anhydride thereof, a copolymerizable monomer containing a sulfonic acid group, and a copolymerizable monomer containing a phosphoric acid group.

6. The pressure-sensitive adhesive composition of claim 5, characterized in that the copolymerizable monomer containing a carboxyl group is (meth)acrylic acid, carboxyethyl acrylate, carboxypentyl acrylate, itaconic acid, maleic acid, fumaric acid, or crotonic acid;
the anhydride of copolymerizable monomer containing a carboxyl group is maleic anhydride or itaconic anhydride;
the copolymerizable monomer containing a sulfonic acid group is styrene sulfonic acid, allyl sulfonic acid, 2-(meth)acrylamide-2-methyl propane sulfonic acid, (meth)acrylamide propane sulfonic acid, sulfopropyl (meth)acrylate, or (meth)acryloyloxy naphthale sulfonic acid; and
the copolymerizable monomer containing a phosphoric acid group is 2-hydroxyethyl acryloyl phosphate.

7. The pressure-sensitive adhesive composition of claim 3, characterized in that the vinyl monomer containing a hydroxyl group is one or more selected from the group consisting of 2-hydroxyethyl (meth)acrylate, 2-hydroxypropyl (meth)acrylate, 2-hydroxyethyleneglycol (meth)acrylate, 2-hydroxypropyleneglycol (meth)acrylate and a mixture thereof.

8. The pressure-sensitive adhesive composition of claim 3, characterized in that the acrylic copolymer further comprises a functional monomer of Formula 1 in 0 to 20 parts by weight relative to weight of total monomers: 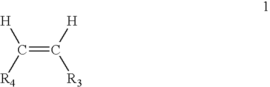
wherein,
R₄ represents hydrogen or alkyl,
R₃ represents cyano, phenyl unsubstituted or substituted with alkyl, acetyloxy, or COR₅, where R₅ represents amino or glycidyloxy unsubstituted or substituted with alkyl.

9. The pressure-sensitive adhesive composition of claim 3, characterized in that the acrylic pressure-sensitive adhesive further comprises 0.01 to 10 parts by weight of a cross-linking agent relative to 100 parts by weight of an acrylic copolymer.

10. The pressure-sensitive adhesive composition of claim 9, characterized in that the cross-linking agent is one or more selected from the group consisting of an isocyanate compound, an epoxy compound, an aziridine compound, and a metal chelate compound.

11. The pressure-sensitive adhesive composition of claim 10, characterized in that the isocyanate compound is one or more multifunctional isocyanate compounds selected from the group consisting of tolylene diisocyanate, xylene diisocyanate, diphenylmethane diisocyanate, hexamethylene diisocyanate, isoform diisocyanate, tetramethylxylene diisocyanate, naphthalene diisocyanate, and a reactant thereof with polyol.

12. The pressure-sensitive adhesive composition of claim 10, characterized in that the epoxy compound is one or more selected from the group consisting of bisphenol A-epichlorohydrine typed epoxy resin, ethyleneglycol diglycidylether, polyethyleneglycol diglycidylether, triglycidylether, glycerine diglycidylether, glycerine triglycidylether, 1,6-hexanediol diglycidylether, trimethylolpropane triglycidylether, diglycidylether aniline, N,N,N′N′-tetraglycidyl-m-xylenediammine, N,N,N′N′-tetraglycidylethylenediamine, or N,N,N,N-tetraglycidyl-1,3-dimethylbenzene.

13. The pressure-sensitive adhesive composition of claim 3, characterized in that the cross-linking density of acrylic copolymer is 1 to 95%, and the weight average molecular weight is 600,000 to 2,000,000.

14. The pressure-sensitive adhesive composition of claim 3, characterized in that the acrylic pressure-sensitive adhesive further comprises 0.01 to 10 parts by weight of a silane coupling agent.

15. The pressure-sensitive adhesive composition of claim 14, characterized in that the silane coupling agent is one or more selected from the group consisting of β-(3,4-epoxycyclohexyl), γ-glycycloxypropyl trimethoxysilane, γ-glycycloxypropyl methyldiethoxysilane, γ-glycycloxypropyl tri-ethoxysilane, 3-mercaptopropyl trimethoxysilane, vinyl trimethoxysilane, vinyl tri-ethoxysilane, γ-methacryloxypropyl trimethoxysilane, γ-methacryloxypropyl tri-ethoxysilane, γ-aminopropyl triethoxysilane, 3-isocyanatepropyl triethoxysilane, and γ-acetoacetatepropyl trimethoxysilane.

16. The pressure-sensitive adhesive composition of claim 3, characterized in that the acrylic pressure-sensitive adhesive further comprises 1 to 100 parts by weight of a tackifier resin relative to 100 parts by weight of an acrylic copolymer.

17. The pressure-sensitive adhesive composition of claim 16, characterized in that the tackifier resin is one or more selected from the group consisting of a (hydrogenated) hydrocarbon resin, a (hydrogenated) rosin resin, a (hydrogenated) rosin ester resin, a (hydrogenated) terpene resin, a (hydrogenated) terpene phenol resin, a polymerized rosin resin, and a polymerized rosin ester resin.

18. The pressure-sensitive adhesive composition of claim 3, characterized in that the pressure-sensitive adhesive further comprises one or more additives selected from the group consisting of near infrared absorbents, epoxy resins, hardeners, plasticizers, ultraviolet stabilizers, antioxidants, colorants, reinforcing agents, and fillers.

19. A pressure-sensitive adhesive film comprising
a release film; and
a pressure-sensitive adhesive layer, formed on the release film, containing a pressure-sensitive adhesive composition according to claim 1.

20. An optical filter comprising a pressure-sensitive adhesive layer containing a pressure-sensitive adhesive composition according to claim 1.

21. The optical filter of claim 20, characterized in that it comprises a transparent substrate;
an antireflective light transmission film (AR film) formed on one side of the transparent substrate;
a near infrared barrier layer (NIR), a neon cut film, and an electromagnetic interference film, laminated on the other side.

22. A plasma display panel (PDP) display device comprising
a plasma display module; and
an optical filter according to claim 20.
